(19) United States
(12) Patent Application Publication
(10) Pub. No.: US 2002/0029711 A1
(43) Pub. Date: Mar. 14, 2002

(54) Methods of preparing positive-working lithographic printing plates for laser-imageable computer-to-press systems

(76) Inventor: Richard J. D'Amato, South Hadley, MA (US)

Correspondence Address: Steven A. Carlson, SAMPSION & ASSOCIATES, P.C., 50 Congress Street, Boston, MA, 02109, US

(21) Appl. No.: 09/865,862

(22) Filed: May 25, 2001

Related U.S. Application Data
(60) Provisional application No. 60/208,030, filed on May 30, 2000.

(51) Int. Cl. B41C 1/10; B41F 1/18; B41F 7/00

(52) U.S. Cl. 101/467; 101/450.1

(57) ABSTRACT

Provided are methods of preparing a positive-working lithographic printing plate, which methods comprise the steps of (a) providing a positive-working lithographic plate, such as a wet lithographic plate, imageable by laser radiation, which plate comprises an ink-accepting layer, such as an ink-accepting surface layer, (b) imagewise directing a source of radiation to image a first region of the ink-accepting layer in a desired pre-exposed pattern, and (c) imagewise directing laser radiation to image a second region of the ink-accepting layer in a desired final printing pattern, wherein at least a portion of the first region is not capable of being imaged during step (c) due to positioning of the plate during the exposure to the laser radiation and wherein the portion of the first region comprises areas which are capable of being inked and transferring ink to a receiver substrate during lithographic printing. Also provided are imaged lithographic plates prepared by such methods.

### RELATED APPLICATIONS

This application claims priority to U.S. Provisional Patent Application Ser. No. 60/208,030, filed May 30, 2000, the disclosure is incorporated fully herein for all purposes.

### FIELD OF THE INVENTION

The present invention relates generally to the field of lithographic printing plates. More particularly, the present invention pertains to methods of preparing positive-working lithographic printing plates, wherein the methods include a step of pre-exposing selected regions of a laser-imageable printing plate to a source of radiation prior to the step of laser imaging of the plate in the desired imagewise exposure for printing. This pre-exposure is done in areas of the ink-accepting layer of the plate which subsequently may not be possible to image in the desired computer-to-press, computer-to-plate, or other positive-working lithographic plate imaging systems for use in lithographic press runs. Optionally, the pre-exposed plate areas may be cleaned or developed to remove any residue of the pre-exposed ink-accepting layer prior to the laser imaging in the computer-to-press or other laser imaging equipment to provide the finished plate for use in printing press runs. The present invention also pertains to imaged lithographic printing plates ready for lithographic press runs made by such methods of preparing positive-working plates.

### BACKGROUND OF THE INVENTION

Lithographic printing has long been the most widely used printing technique, especially for short to medium printing run lengths of 1,000 to 250,000. The term “lithographic” is meant to include various terms used synonymously, such as offset, offset lithographic, planographic, and others.

With the advent of the computer in revolutionizing the graphics design process leading to printing, there have been extensive efforts to develop convenient and inexpensive computer-to-plate and computer-to-press systems, particularly for use in lithographic printing. One non-impact printing system which has received attention for economics and convenient computer-to-plate and computer-to-press preparation for lithographic printing is laser ablation or laser thermal imaging. Examples of laser-induced thermal ablation techniques for computer-to-plate applications include U.S. Pat. Nos. 5,339,737; 5,353,705; and 5,493,971, the disclosures of which are hereby incorporated by reference into the present disclosure.

By the term “wet lithographic,” as used herein, is meant the type of lithographic printing plate where the inking areas of the plate that receive the printing ink from the ink roller and then transfer this ink to the receiving substrate, such as a type of paper, are ink-accepting or oleophilic and where the non-inking areas of the plate that do not accept printing ink from the ink roller and thus do not transfer any ink to the receiving media are hydrophilic and receive an aqueous dampening or fountain solution during the printing process before contact with the ink roller. This aqueous or “wet” layer in the non-inking areas renders these areas ink repellent or oleophobic to the printing ink, but does not affect the oleophilic character of the ink-accepting areas. By the term “positive-working,” as used herein, is meant that the inking or image areas of the plate that receive the printing ink are not removed by the laser imaging method of preparing the imaged lithographic plate. By the term “printing plate” or its equivalent term “plate,” as used herein, is meant any type of printing member or surface capable of recording an image defined by regions exhibiting differential affinities for ink and/or fountain or other ink-abhesive fluid.

One difficulty in the laser imaging of positive-working lithographic printing plates, especially in the desirable computer-to-plate and computer-to-press systems of use, is that significant areas of the plate, which are bent, covered, outside the laser exposure region, or otherwise may be improperly positioned, are out of focus or inaccessible to the laser exposure and do not thus get imaged. After any processing of the plate to clean and create the final image ready for press runs, these unexposed or underexposed areas remain ink-accepting and thus may undesirably produce printed images during printing on the press.

### SUMMARY OF THE INVENTION

One aspect of the present invention pertains to a method of preparing a positive-working lithographic plate, which method comprises the steps of (a) providing a positive-working lithographic plate imageable by laser radiation, comprising an ink-accepting layer, (b) imagewise directing a source of radiation to image a first region of the ink-accepting layer, and (c) imagewise directing laser radiation to image a second region of the ink-accepting layer, wherein at least a portion of the first region is not capable of being imaged during step (c) due to positioning of the plate during the exposure to the laser radiation and wherein the portion of the first region comprises areas which are capable of being inked and transferring ink to a receiver substrate during lithographic printing. Thus, in the absence of the pre-exposure step (b), the at least a portion of the first region may not be imaged during step (c) due to positioning of the plate during the exposure to laser radiation and the portion of the first region comprises areas that may be inked and may transfer ink in undesired or unwanted areas to receiver substrates during lithographic printing. In a preferred embodiment, the plate of step (a) is a wet lithographic plate, and the ink-accepting layer is a surface layer of the plate.

The methods of this invention are advantageous in preventing such unwanted printing on receiver substrates resulting from an ink-accepting layer of the positive-working plates in areas which are bent, covered, or otherwise not positioned properly when the plate is fastened to the laser imaging equipment for imagewise laser imaging. Thus, these bent and other areas are out of focus or inaccessible to the laser exposure and do not receive enough laser radiation to be imaged. After any processing of the plate to clean and create the final image ready for use in press runs, these unexposed or underexposed areas remain ink-accepting, and thus significant areas may undesirably cause imaging on receiver substrates during printing on the press. The pre-exposure step of the methods of the present invention is done in these areas which subsequently may not be possible to image in the desired computer-to-press, computer-to-plate, or other positive-working lithographic plate imaging systems for use in lithographic printing. The methods of the present invention thus overcome these unwanted ink-accepting areas by pre-exposing these areas to a source of radiation, such as a laser or a flash lamp, and, optionally in a preferred embodiment, developing or cleaning these pre-exposed patterned areas prior to the laser imaging in the computer-to-press or other laser imaging systems to provide the imaged plate ready for use in printing.

This pre-exposure may be programmed into a laser exposure unit or other source of radiation to remove the ink-accepting layer of the positive-working plate in those selected areas which subsequently may be bent, covered up, or otherwise inadequately exposed when the full or final printable image is made on the plate. For example, this pre-exposure with optional cleaning or development before final laser imaging may involve pre-exposing a thin strip on the edges of the plates in the machine direction both at the time of coating the plates and later at the time of printing with the plates, as well as pre-exposing selected bands in the tranverse machine direction both at the time of coating the plates and later at the time of printing with the plates where these bands include areas, for example, where the plate is clamped or bent to attach it to the exposure platform during the final laser imagewise exposure. In contrast to the complexity of preparing positive-working plates in a variety of coating patterns with tranverse and in-machine coating direction gaps, the methods of this invention allow the much easier full surface coating of the laser-imageable positive-working lithographic plates since the pre-exposure step provides the desired pattern of non-image areas on the plate to overcome the problem of the unwanted ink-accepting areas, as described herein.

Another aspect of the present invention pertains to imaged lithographic plates prepared by the methods of this invention, as described herein.

### BRIEF DESCRIPTION OF THE DRAWINGS

FIG. 1 shows an imaged lithographic plate with (a) unwanted ink-accepting areas and with (b) no unwanted ink-accepting areas when the plate is prepared by the methods of the present invention.

FIG. 2 shows several steps of one embodiment of a method of preparing a positive-working lithographic plate of this invention where the pre-exposure step is done in an in-line process on a continuous web of lithographic plate material.

FIG. 3 shows a flow diagram of one embodiment of a method of preparing a positive-working lithographic plate of the present invention for a computer-to-press application.

### DETAILED DESCRIPTION OF THE PREFERRED EMBODIMENTS OF THE INVENTION

### Methods of Preparing Positive-working Lithographic Printing Plates

One aspect of the methods of preparing positive-working lithographic printing plates of the present invention comprises a step of exposing an ink-accepting layer of the plate to a source of radiation in a first desired imagewise pattern, thereby forming a pattern in the ink-accepting layer in the exposed regions thereof to provide a desired imaged pattern or region in the plate which may not otherwise be imaged due to clamping, bending, or other positioning during computer-to-press imaging or other laser imaging during a subsequent laser exposure step in a second desired imagewise pattern to make the finished imaged plate for lithographic printing.

In a preferred embodiment of the methods of the present invention, the plate is a positive-working wet lithographic printing plate. Advances in printing inks are expected to increasingly promote the use of positive-working plates with inks that do not require a fountain solution to provide the ink repellency of the non-image areas during press runs. For example, Flint Ink, Ann Arbor, Mich., has developed SFI (a trademark for printing inks from Flint Ink) Single Fluid Ink technology, as announced at DRUPA 2000 on May 18, 2000, which would not require a fountain solution. Thus, the methods of this invention are also applicable to positive-working lithographic plates that do not require a wet lithographic printing process, such as is possible with certain types of printing inks.

Suitable positive-working printing plates for the methods of this invention include, but are not limited to, plates known in the art of laser-imageable positive-working lithographic printing plates for computer-to-press systems. The substrates for these plates may be any of the metal substrates, such as aluminum; paper substrates; and plastic substrates, known in the art of substrates for lithographic printing plates.

The unwanted printed areas during press runs that are overcome by the methods of this invention may be illustrated by the following example. During computer-to-press imaging, the laser-imageable positive-working lithographic printing plate is fastened or attached to a cylinder of the press prior to laser exposure and subsequent press runs. The fastening is typically done with clamps on two opposite edges of the plate with the plate being bent at these edges in order to be held by the clamps. These clamped and bent edges may not be positioned from a laser focus or laser beam access standpoint such that the desired imagewise laser exposure properly images some or all of these edges. Since the lithographic printing plate is positive-working, these non-imaged or under-imaged areas are still capable of picking up the printing ink and transferring an image to the receiving substrate during the press run. Thus, to the extent that these non-imaged or under-imaged areas come into contact with the ink roller of the press, undesirable printed areas will be formed on the receiver substrates during the press run.

To overcome this issue of unwanted printed areas during press runs, the methods of the present invention utilize a step of pre-exposure of such potential non-imageable printable regions of the plate to a source of radiation, such as to a laser or to a flash lamp, to produce a laser-imageable positive-working lithographic printing plate that is ready for use on a computer-to-press, computer-to-plate, or other laser imaging equipment where positioning of the plate may otherwise produce these unwanted printed areas. The pre-exposed regions may be cleaned to remove residue present in these pre-exposed regions either before or after subsequent laser imaging on the computer-to-press or other laser imaging equipment.

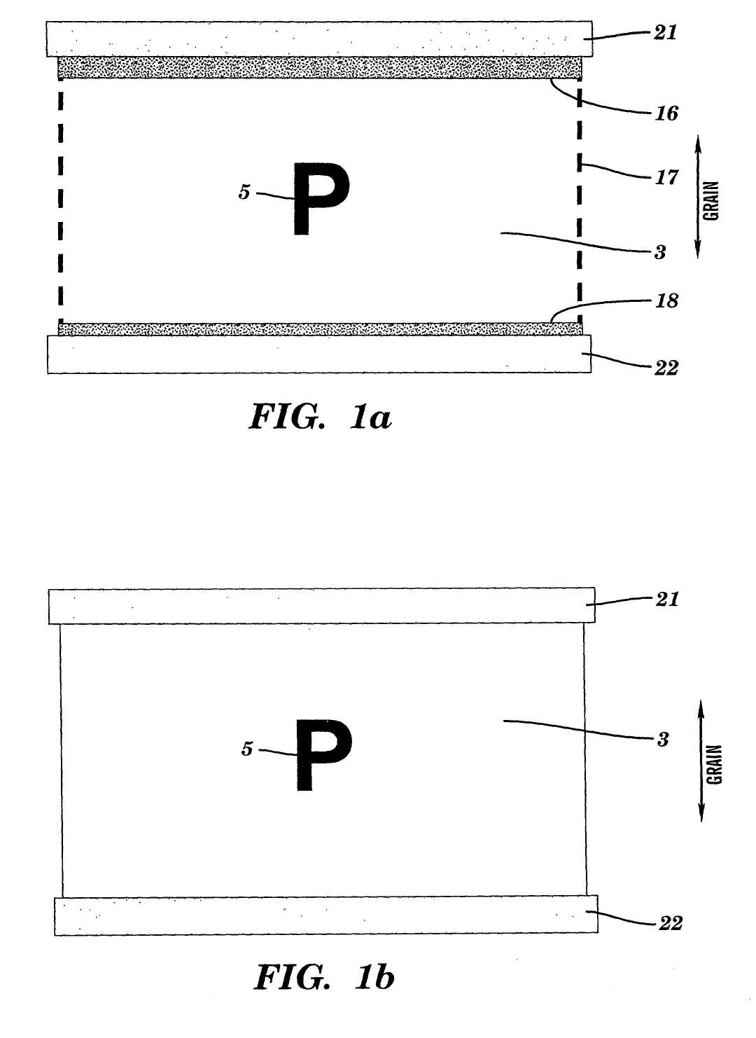

Referring to FIG. 1a, examples of the sources of these unwanted printed areas are illustrated by a top down representational view of unexposed or underexposed areas 16, 17, and 18 of a laser exposed and processed lithographic plate with exposed, nonprinting area 3 and with unexposed, printing area 5. The plate is clamped on one end by a press tail clamp area 21 and on an opposite end by a press head clamp area 22. Depending on their ability to contact the ink roller during press runs and on the size of the receiving substrate in printing, areas 16, 17, and 18 will produce an undesired printing area on the receiving substrates during press runs. For example, area 16 may be formed by an unexposed area of a plate that was under the platesetter tail clamp in computer-to-plate applications or, alternatively, was at the tail clamp bend in computer-to-press applications. Similarly, for example, area 18 may be formed by an unexposed area of a plate that was under the platesetter head clamp in computer-to-plate applications and at the head clamp bend in computer-to-press applications. Also, for example, area 17 may be formed by an unexposed or underexposed area of a plate due to an out of focus condition on the edge of the plate in either computer-to-plate or computer-to-press applications. Although areas 16, 17, and 18 may be very narrow in width, they may still produce an objectionable printed area on the receiving substrate during press runs instead of the printed image only being produced by the desired image area 5.

To overcome such problems of unwanted printed areas as illustrated in FIG. 1a, the methods of this invention provide a lithographic printing plate without areas 16, 17, and 18, as illustrated in FIG. 1b. This preparation of a laser exposed, imaged lithographic plate with only exposed, non-printing area 3 and unexposed, printing area 5 is done by a method of pre-exposing at least the areas corresponding to areas 16, 17, and 18 to a source of radiation with subsequent optional cleaning, prior to laser imaging of the remaining areas of the plate, thereby avoiding the non-exposure or under-exposure during laser imaging due to clamping and positioning as illustrated by the imaged plate of FIG. 1a and providing a defect-free imaged plate as illustrated in FIG. 1b.

The pre-exposure and optional cleaning steps of the present invention are advantageous for forming the desired imagewise pattern in the positive-working lithographic printing plate, wherein the pattern is matched with the specific requirements of the laser imaging equipment and of the size and type of the laser-imageable plate. Due to the wide variety of laser imaging equipment and of sizes and types of plates used in positive-working lithographic printing, the methods of the present invention are more flexible and economical in comparison to other methods of patterning coated products, such as lane and/or intermittent coating to form coated or overcoated patterns as is known, for example, in the art of battery electrode fabrication.

The pre-exposure to a source of radiation of the methods of this invention may be done by a variety of processes. These include, for example, pre-exposure in an off-line step where the lithographic printing plate is not in a web form on either a coating line or a sheet cutting line and is typically in a cut sheet form either of the exact size for use on the laser imaging equipment or of a larger size which will be subsequently reduced to the exact size for the laser imaging equipment. Also, these include, for example, pre-exposure in an in-line step where the lithographic printing plate is in a web form on either a coating line or a sheet cutting line or is no longer in a continuous web form in some part of a continuous sheet cutting line, as is known in the art of the coating and sheet cutting of lithographic printing plates.

The patterning pre-exposure of the methods of this invention may utilize a wide variety of sources of radiation to effectively expose the desired areas of the lithographic plate such that these pre-exposed areas, preferably with a subsequent cleaning and gumming up step, are rendered non-printing during the lithographic press run. The sources of radiation may be of a lower resolution, of non-laser types, and of a higher power than the laser radiation used in the computer-to-press or other laser imaging equipment to prepare the imaged plate ready for use in the press run. Examples of suitable sources of radiation include, but are not limited to, lasers, such as semiconductor diode lasers, YAG lasers, and carbon dioxide lasers; pulsed lamps, such as pulsed xenon lamps; and continuous light sources, such as mercury and carbon arc light sources.

When the pre-exposure patterning step is done in an off-line mode, for example, with a cut sheet of the lithographic plate, the desired imagewise pre-exposure may be done by a wide variety of imaging techniques known in the art of imaging a photosensitive coating. For example, suitable methods include, but are not limited to, a computer-controlled imagewise pre-exposure utilizing a laser or a set of multiple lasers which are scanned over the plate with provisions to maintain an effective imaging focus, and a flash lamp or continuous light source exposure through a mask having the desired imagewise pattern. Since the plates are subsequently imaged on a laser-imaging computer-to-press or other imaging equipment, the incident energy and time duration of the pre-exposure patterning step are preferably similar to the laser imaging conditions desired during the subsequent laser imaging. For example, the less than millisecond exposure times of laser imaging are preferred for the pre-exposure patterning step. Also, it is important not to use excessive incident energy and/or time durations during the pre-exposure patterning step since it is sufficient that the desired regions of the printable layer of the positive-working plate are imaged by the pre-exposure step, and excessive pre-exposure conditions may produce unwanted results.

One advantage of the methods of this invention is that the pre-exposure patterning step may be conveniently done to the desired pattern to suit a particular laser imaging equipment and plate type, grain direction preference, and size on an off-line basis in response to specific orders received from customers. For example, typically, it is preferred that the grain or machine coating direction of the plate be perpendicular to the clamps 21 and 22, as illustrated in FIG. 1b. This generally provides greater durability during press clamping and during the subsequent press run. The methods of the present invention are advantageous in providing pre-exposure patterning that may conveniently be used to provide plates with the grain direction in the preferred direction and ready for computer-to-plate or computer-to-press laser imaging.

In order to prepare plates for computer-to-plate and computer-to-press applications with the grain direction for mounting on the imaging and/or printing cylinder in the preferred direction utilizing a coating approach to manufacture the plates, an intermittent or “patch” coating process, as known, for example, in the art of coating lithium ion battery electrodes, would typically be used. This requires specialized coating application equipment with modifications for each different coating patch size and often slows the line speed for the coating application. Also, the patch coating approach must be matched at the time of coating to the customer requirements for each specific patch size, and these patch sizes may vary over a wide range of less than 3 feet to more than 5 feet. Further, if there is a need to also eliminate potential unwanted printable regions on the other two edges of the plate, as, for example, illustrated by area 17 in FIG. 1a, a coating approach to do the preferred grain direction by intermittent coating would also need to do stripe or “lane” coating in the machine direction, as is also known, for example, in the art of coating lithium ion battery electrodes. This places an additional requirement on specialized coating equipment with modifications for each different coating lane position and on matching, at the time of coating, the lane coating to the customer requirements for each specific plate size.

The methods of the present invention are advantageous in conveniently doing a pre-exposure of regions of both the machine direction and the transverse direction of coating, as well as doing pre-exposure of other, non-linear patterns which would require other specialized coating application equipment such as individual gravure coating cylinders for each desired pattern. The pre-exposure step may be done either in an inline, post-coating mode or in an off-line mode, as described herein. Thus, this pre-exposure process may be carried out to prepare plates ready for computer-to-plate and computer-to-press use without involving complex coating application equipment and processes. For example, the positive-working plates could be pre-exposed to remove selected ink-accepting areas at the factory where the laser-imaging coatings are applied and then shipped to customers for computer-to-press and similar plate-making uses.

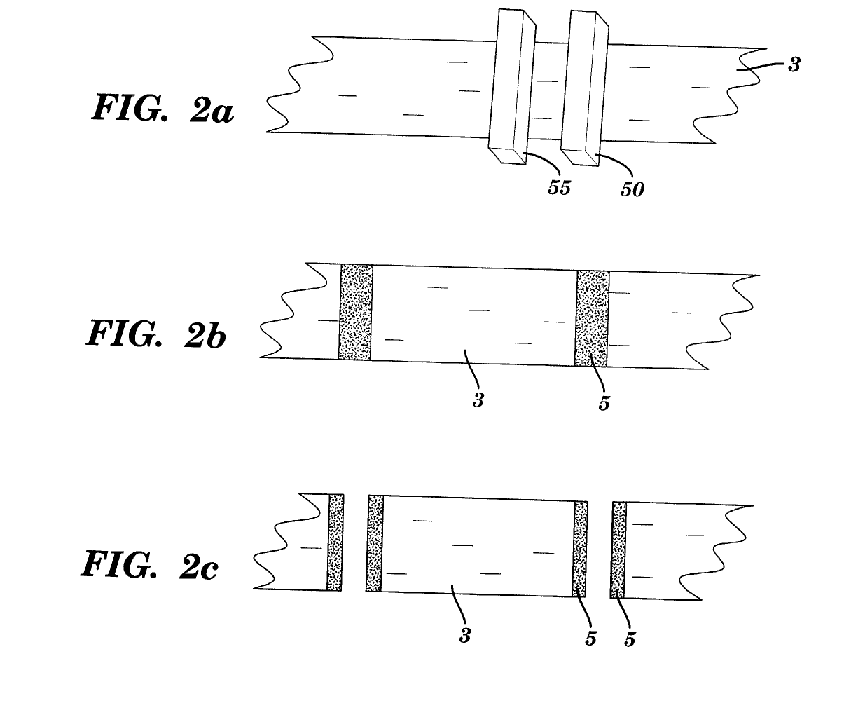

Referring to FIG. 2, a variety of sources of radiation and methods of imaging may be utilized for the pre-exposure patterning step in an in-line mode. As illustrated in FIG. 2 in a representational top down view, in one embodiment, A represents a positive-working lithographic printing plate web material suitable for the methods of this invention where the uneven edges on opposite ends represent the continuous nature of the web, 50 and 55 represent sources of radiation, and 3 in A, B, and C in FIG. 2 represents the surface of this plate web material. Also, as shown in FIG. 2, B represents this web-based plate material after it has been pre-exposed and cleaned in-line according to an embodiment of the methods of this invention to form a band or area 5 of non-ink accepting, hydrophilic area across the web at a position and of a width that is appropriate for the desired final plate size and removal of potential unwanted printable areas on the plate. Also, as shown in FIG. 2, C represents the web after it has been cut in-line to the desired plate size through cutting within the pre-exposed patterned area 5 formed by the methods of this invention. The short dotted lines in FIG. 2 represent the grain direction both of the substrate of the web, such as a metal substrate, and of the surface of the lithographic plate material.

The imaging techniques to form the desired pre-exposure patterning in an in-line mode may be any of the imaging techniques known in the art for forming an image on a moving web of a photo-sensitive material. For example, suitable methods include, but are not limited to, (1) scanning a properly focused laser beam in a direction at an angle to the web direction of travel and at a scan rate suitable to produce the desired imagewise pre-exposure pattern and (2) using an opaque mask of the desired imagewise pre-exposure pattern with a pulsed laser or a flash lamp with short dwell times or with a continuous light source through an on-off shutter with short dwell times for exposure. To aid in maintaining the focusing of the scanning laser, part of the laser writing head might be in contact with the desired pre-exposed areas since these pre-exposed areas will not subsequently be utilized for printing during the press run. Since the typical line speeds of production coating lines for laser-imageable lithographic printing plates are moderate and in the range of 15 to 150 feet per minute, it is a reasonable alternative to do the pre-exposure patterning in-line, but this would be expected to be more difficult if the line speeds were much faster. Also, it is known in the art of the coating and sheet cutting of continuous webs to use an accumulator process on the continuous web coating and sheet cutting lines to temporarily stop a section of the web so it may be, for example, cut or spliced. Accordingly, the pre-exposure patterning step may also be carried out on the web when it is in this type of a temporary stopped position, either while the plate is still part of the continuous web plate material or when the plate has been cut from the continuous web plate material.

Another aspect of the methods of preparing positive-working lithographic printing plates of this invention comprises the steps of (a) providing a positive-working lithographic plate imageable by laser radiation, comprising an ink-accepting layer; (b) imagewise directing a source of radiation to image the ink-accepting layer in a first desired region; (c) optionally, contacting the plate with a cleaning solution to remove residue present from the exposed ink-accepting layer in the first desired region of step (b); and (d) imagewise directing laser radiation to image the ink-accepting area in a second desired region, wherein at least a portion of the first desired region is not capable of being imaged during step (d) due to positioning of the plate during the exposure to laser radiation and wherein the portion of the first region comprises areas which are capable of being inked and transferring ink to a receiver substrate during lithographic printing. In a preferred embodiment, there is a further step (e) comprising contacting the plate with a cleaning solution to remove residue present from the imagewise exposed regions of step (d).

In one embodiment of the methods of preparing positive-working lithographic printing plates of this invention, the cleaning solution comprises water. For example, the plate may be cleaned in further step (e) by rubbing with a cloth that has been wet with water or by contact with a fountain solution, which typically contains very high volume percentages of water, during the setup and operation of a wet lithographic printing press. A wide variety of cleaning solutions and post-laser imaging cleaning steps and methods for their use, as known in the art for cleaning laser-imageable positive-working lithographic printing plates, may be utilized in this invention, such as, for example, those described in U.S. Pat. Nos. 5,339,737; 5,353,705; 5,385,092; 5,487,338; and 5,493,971, the disclosures of which are hereby incorporated by reference into the present disclosure. A suitable cleaning solution does no damage either to the surface layer or to unexposed intermediate layers thereunder or to the support.

In wet lithographic computer-to-press systems or “direct imaging presses,” as computer-to-press systems are often called, the cleaning solution is typically the fountain solution which is a nearly neutral solution without strong developing chemicals present to clean or remove the laser imaged areas. These types of cleaning solutions are often referred to as “No Process” cleaning solutions because of the absence of highly alkaline and other aggressive plate developing materials. As such, it is preferable that the pre-exposure step of the methods of this invention be sufficient that the pre-exposed regions may be cleaned or removed as desired by a cleaning solution of these nearly neutral or close to pH 7 types. It is preferable that a first cleaning step be done on the pre-exposed plates prior to the laser imaging step that is done, for example, on computer-to-plate or computer-to-press systems. This first cleaning step may be done as part of an in-line pre-exposure process or may be done in an off-line cleaning process after either an in-line or an off-line pre-exposure step.

In another embodiment of the methods of this invention, the first cleaning step after the pre-exposure patterning step may be done after the laser imaging step that is done, for example, on computer-to-plate or computer-to-press equipment. Preferably, in this case, the first cleaning step of the pre-exposed areas is done as part of the overall cleaning of the plate, including the laser imaged areas that are cleaned to prepare the plate for press runs.

If the first cleaning step is done prior to the laser imaging step that is done, for example, on computer-to-plate or computer-to-press equipment, there is typically a second cleaning step after this laser imaging step to clean the laser imaged areas, as is known in the art of laser-imageable positive-working lithographic plates.

After any first and/or second cleaning steps of the methods of the present invention, it is preferable to desensitize the plate by applying a gum solution to the plate, as is known in the art of desensitizing positive working lithographic plates, as, for example, described in U.S. Pat. No. 4,731,119 to Toyama, et al., the disclosures of which are fully incorporated herein by reference. This desensitization or gumming up step may be advantageous in providing a protective coating to the pre-exposed regions to protect the plate from contamination, scratching, and chemical changes during storage prior to laser imaging and press runs. Also, a gumming up step is also a preferred step after the laser imaging step to help increase the hydrophilic properties of the laser imaged regions of the plate, as is known in the art of positive-working lithographic printing. Suitable gum materials for positive-working lithographic plates include, but are not limited to, gum arabic, carboxy alkylated starch, and dextrin.

Preferred positive-working wet lithographic printing plates for use in this invention include, but are not limited to, the plates with a durable hydrophilic layer next to the substrate, such as aluminum, of the plate, as disclosed in PCT Publication Nos. WO 99/37481, 99/37482, and 00/16988 to Rorke, et al., the disclosures of which are fully incorporated herein by reference. These plates with a durable hydrophilic layer are particularly preferred for use with the methods of this invention since the durable hydrophilic layer helps to lessen the need for desensitization by a gumming up step when the pre-exposure patterning step is done off line, for example at the coating factory, at a significant time period before the subsequent laser imaging on a computer-to-press or other laser imaging system.

After the pre-exposure step and any cleaning and gumming up steps on the pre-exposed regions of the plates in the methods of this invention, the plates are mounted on the computer-to-plate or computer-to-press equipment as known in the art of laser imaging computer-to-plate and computer-to-press equipment and systems, such as, for example, the laser imaging equipment and systems available from Presstek, Inc., Hudson, N.H., and Creo Products, Inc., Burnaby, BC.

After mounting the plates, the plates are imaged by a laser in a desired imagewise pattern to provide the image and non-image areas of the plate. After any cleaning step required to clean or remove the laser-imaged areas, as well as to clean or remove the pre-exposed pattern regions if a prior cleaning step has not already been done on these regions, and after any gumming-up step, the plate is ready for printing the desired press run.

For example, for computer-to-plate applications, in one embodiment of the methods of preparing positive-working lithographic printing plates of this invention, subsequent to any steps of cleaning and gumming up after laser imaging, the plate is inked and used in press runs on a lithographic printing press. Also, for example, for computer-to-press applications, in one embodiment, the pre-exposed plate is mounted on a lithographic printing press before the laser imaging step is carried out. This embodiment has the advantage of direct computer-to-press or on-press imaging of the positive-working lithographic printing plate instead of a separate off-press imaging step and subsequent mounting of the imaged plate on the printing press.

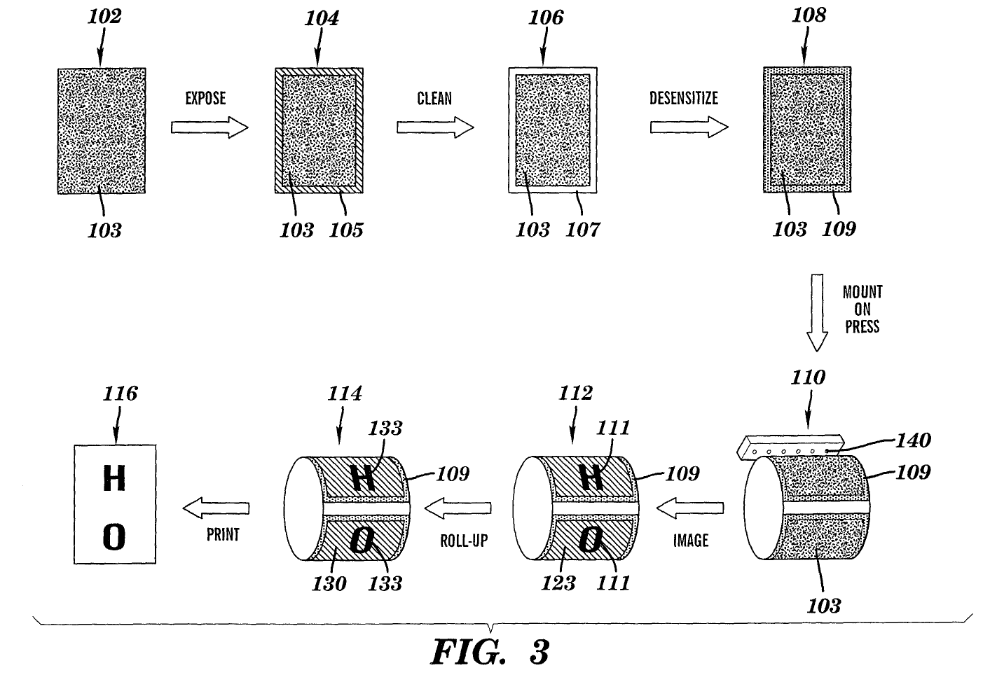

Referring to FIG. 3, one embodiment of the methods of the present invention is illustrated for a computer-to-press system. A positive-working lithographic printing plate 102, suitable for use in the methods of this invention, with a surface 103, prior to any imaging steps, is pre-exposed in an exposure step to a source of radiation in region 105 to form a plate 104 with a pre-exposed pattern in a “frame” configuration to avoid potential unwanted printable areas from bends in clamping and inadequate laser focus during subsequent laser imaging. Plate 104 is then cleaned using a cleaning solution to provide plate 106 with the pre-exposed region of the “frame” pattern cleaned to remove any residue to provide pre-exposed, cleaned region 107. Plate 106 is then gummed up or desensitized to form plate 108 with the pre-exposed, cleaned region of the “frame” pattern gummed up to protect the pre-exposed, cleaned region during storage and prior to subsequent laser imaging and use in printing. Plate 108 with its pre-exposed, cleaned, and gummed up region 109 is then mounted on the imaging and printing press plate cylinder of a computer-to-press laser imaging system with laser exposure device 140 to provide mounted plate 110 with surface area 103 having no pre-exposure and with pre-exposed, cleaned, and gummed up region 109. Plate 110 is then exposed to the desired imagewise laser exposure to provide plate 112 with non-exposed image area 111 and exposed non-image area 123 together with retention of the pre-exposed, cleaned, and gummed up region 109. After “roll-up” on the press with any fountain solution and gumming up solution and with contact to the printing ink, plate 112 is converted to plate 114 with inked image area 133 and with non-inked non-image areas 130 and 109. Transfer of ink from the inked image area 133 to a receiver substrate forms a printed substrate 116 with ink images in regions corresponding to area 133 and with no ink images in regions corresponding to areas 130 and 109.

Imaged Lithographic Printing Plates

Another aspect of the present invention pertains to imaged lithographic printing plates prepared by the methods of this invention, as described herein. In one embodiment, an imaged lithographic plate is prepared by a method comprising the steps of (a) providing a positive-working lithographic plate imageable by laser radiation, comprising an ink-accepting layer, (b) imagewise directing a source of radiation to image a first region of the ink-accepting layer, and (c) imagewise directing laser radiation to image a second region of the ink-accepting layer, wherein at least a portion of the first region is not capable of being imaged during step (c) due to positioning of the plate during the exposure to the laser radiation and wherein the portion of the first layer comprises areas which are capable of being inked and transferring ink to a receiver substrate during lithographic printing. In a preferred embodiment, the lithographic plate is a wet lithographic plate, and the ink-accepting layer is a surface layer.

While the invention has been described in detail and with reference to specific embodiments thereof, it will be apparent to one skilled in the art that various changes and modifications can be made without departing from the spirit and scope thereof.

1. A method of preparing a positive-working lithographic plate, which method comprises the steps of:
(a) providing a positive-working lithographic plate imageable by laser radiation, comprising an ink-accepting layer;
(b) imagewise directing a source of radiation to image a first region of said ink-accepting layer; and
(c) imagewise directing laser radiation to image a second region of said ink-accepting layer, wherein at least a portion of said first region is not capable of being imaged during step (c) due to positioning of the plate during the exposure to said laser radiation and wherein said portion comprises areas which are capable of being inked and transferring ink to a receiver substrate during lithographic printing.

2. The method of claim 1, wherein said plate of step (a) is a wet lithographic plate and said ink-accepting layer is a surface layer.

3. The method of claim 1, wherein, subsequent to step (b) and prior to step (c), there is a further step comprising contacting said first region of said plate with a cleaning solution to remove residue of said ink-accepting layer from said first region.

4. The method of claim 1, wherein, subsequent to step (c), there is a further step (d) comprising contacting said plate with a cleaning solution to remove residue of said ink-accepting layer from said first and second regions.

5. The method of claim 3, wherein, subsequent to step (c), there is a further step (d) comprising contacting said plate with a cleaning solution to remove residue of said ink-accepting layer from said second region.

6. The method of claim 3, wherein, subsequent to contacting said plate with said cleaning solution, there is a further step of desensitizing said plate with a gum solution.

7. The method of claim 4, wherein, subsequent to contacting said plate with said cleaning solution, there is a further step of desensitizing said plate with a gum solution.

8. The method of claim 5, wherein, subsequent to contacting said plate with said cleaning solution in step (d), there is a further step of desensitizing said plate with a gum solution

9. The method of claim 1, wherein said source of radiation is selected from the group consisting of lasers, flash lamps, and continuous light sources.

10. The method of claim 4, wherein, subsequent to further step (d), said plate is inked and used in press runs.

11. The method of claim 5, wherein, subsequent to further step (d), said plate is inked and used in press runs.

12. The method of claim 3, wherein said cleaning solution comprises water.

13. The method of claim 4, wherein said cleaning solution comprises water.

14. The method of claim 5, wherein said cleaning solution in step (d) comprises water.

15. The method of claim 1, wherein said plate is mounted on a printing press prior to step (c).

16. An imaged lithographic plate prepared by a method comprising the steps of:
(a) providing a positive-working, lithographic plate imageable by laser radiation, comprising an ink-accepting layer;
(b) imagewise directing a source of radiation to image a first region of said ink-accepting layer; and
(c) imagewise directing laser radiation to image a second region of said ink-accepting layer, wherein at least a portion of said first region is not capable of being imaged during step (c) due to positioning of the plate during the exposure to said laser radiation and wherein said portion comprises areas which are capable of being inked and transferring ink to a receiver substrate during lithographic printing.

17. The plate of claim 16, wherein said plate of step (a) is a wet lithographic plate and said ink-accepting layer is a surface layer.
